(19) United States
(12) Patent Application Publication
(10) Pub. No.: US 2025/0060778 A1
(43) Pub. Date: Feb. 20, 2025

(54) Portable, Protective Gaming Case with Built-In Monitor

(71) Applicant: Pei Yu Wu, New Taipei City (TW)

(72) Inventor: Pei Yu Wu, New Taipei City (TW)

(21) Appl. No.: 18/781,178

(22) Filed: Jul. 23, 2024

Related U.S. Application Data
(63) Continuation-in-part of application No. 29/910,368, filed on Aug. 18, 2023.

(51) Int. Cl. G06F 1/16

(52) U.S. Cl. CPC G06F 1/1601

(57) ABSTRACT

The present invention is a portable, protective gaming case allowing users to play video game consoles on-the-go with a built-in monitor and an all-in-one cable solution. The present invention is compatible with a plurality of gaming consoles. The case includes support hinges that provide controlled resistance during the closing motion of the case. Said support hinges allow users to adjust the viewing angle of the built-in monitor. The present invention includes an all-in-one cable solution using a single power cord that connects to a wall AC outlet. Other wires within the case connect to various devices of the present invention, such as the console and the monitor. A user can securely attach the case to a trolley assembly. Said trolley assembly allows the present invention to be portable and moved between use.

### FIELD OF THE INVENTION

The present invention relates generally to portable video game console cases. Particularly, the present invention is a portable, protective gaming case allowing users to play video game consoles on-the-go with a built-in monitor and an all-in-one cable solution.

### BACKGROUND OF THE INVENTION

Console gaming is not traditionally known for portability. Consoles can be cumbersome as they are not usually designed to be handheld. The Nintendo Switch was revolutionary on its release, because it allows users to “switch” between traditional stationary console gaming and portable handheld gaming since the console itself includes a screen. However, there is a lack of portability solutions for other popular consoles such as Sony's Playstation consoles or Microsoft's Xbox consoles.

Typically, a console must be connected to a separate monitor or television. To enable portable console gaming, said console in addition to said monitor or television must be able to be safely transported. Since these components are not designed to be portably handheld, it is necessary to provide a case that can not only hold all of these components together in one but also protect these components from damage.

Another issue that arises is power. A console and a monitor need to be individually provided electricity through separate power cables. To enable portability, it is necessary to provide a solution that minimizes the amount of loose cables occupying volume while maximizing cable management.

An objective of the present invention is to provide a portable gaming case that allows users to play video game consoles on-the-go. The present invention includes a built-in monitor setup that can be used from within the case itself. The case receives power through just one power cable. Users can simply unpack the case and plug in the single power case to an AC outlet to enable portable console gaming. Because of the size and weight of Playstation and Xbox consoles, there must be a solution to provide mobility, such as a trolley. The present invention includes a trolley assembly that allows users to roll the gaming case between use.

Another objective of the present invention is to provide a gaming case that is rugged, protective, water-resistant, and shock-absorbing. The present invention allows users to safely store gaming consoles, monitors, controllers, and other fragile electronics without fear of damage between use.

### SUMMARY OF THE INVENTION

The present invention is a portable, protective gaming case allowing users to play video game consoles on-the-go with a built-in monitor and an all-in-one cable solution.

The present invention is designed to be rugged, protective, and water-resistant, offering shock-absorption and protection against water splashes, rain, and water jets. The present invention is compatible with a plurality of gaming consoles including Playstation 5 Disk, Playstation 5 Digital, Playstation 4 Pro, Playstation 4, Playstation 4 Slim, Xbox One X, or Xbox Series X consoles. The present invention includes a space to fit a controller. The case includes support hinges that provide controlled resistance during the closing motion of the upper case and lower case, ensuring that the upper case closes gently and does not snap shut. Said support hinges allow users to adjust the viewing angle of the upper case with the built-in monitor.

The present invention includes an all-in-one cable solution using a single power cord that connects to a wall AC outlet. Other wires within the case receive power and connect to various devices of the present invention, such as the console and the monitor. A plurality of securing bands can be used to fasten down said wires for cable management and organization.

When the case is in the closed position, a user can securely attach the case to the trolley assembly using a strap. Once secured, a user can roll the trolley assembly by pulling a handle that can extend and retract like common luggage handles. This trolley assembly allows the present invention to be portable and moved between use.

### BRIEF DESCRIPTION OF THE DRAWINGS

FIG. 1 is a front top right perspective view of the present invention.

FIG. 2 is a front top right perspective view of the present invention with the foam screen protector.

FIG. 3 is a front bottom right perspective view of the present invention.

FIG. 4 is a front top left perspective view of the present invention.

FIG. 5 is a front elevational view of the present invention.

FIG. 6 is a rear elevational view of the present invention.

FIG. 7 is a right elevational view of the present invention.

FIG. 8 is a left elevational view of the present invention.

FIG. 9 is a top plan view of the present invention.

FIG. 10 is a top plan view of the present invention showing the blister without a console.

FIG. 11 is a bottom plan view of the present invention.

FIG. 12 is a rear top left perspective view of the present invention.

FIG. 13 is a rear top left perspective view of a monitor with the monitor stand.

FIG. 14 is a rear top left perspective view of the monitor stand.

FIG. 15 is a front top right perspective view of the monitor stand.

FIG. 16 is a front top right perspective view of the present invention in a closed position attached to the trolley assembly.

FIG. 17 is a front bottom right perspective view of the present invention in a closed position attached to the trolley assembly.

FIG. 18 is a rear top left perspective view of the present invention in a closed position attached to the trolley assembly.

FIG. 19 is a rear bottom left perspective view of the present invention in a closed position attached to the trolley assembly.

FIG. 20 is a front right perspective view of the present invention.

FIG. 21 is a front right perspective view of the present invention showing the detachment of a monitor.

FIG. 22 is a front right perspective view of the present invention showing the attachment of a monitor.

### DETAILED DESCRIPTION OF THE INVENTION

All illustrations of the drawings are for the purpose of describing selected versions of the present invention and are not intended to limit the scope of the present invention.

The present invention is a portable, protective gaming case allowing users to play video game consoles on-the-go with a built-in monitor and an all-in-one cable solution.

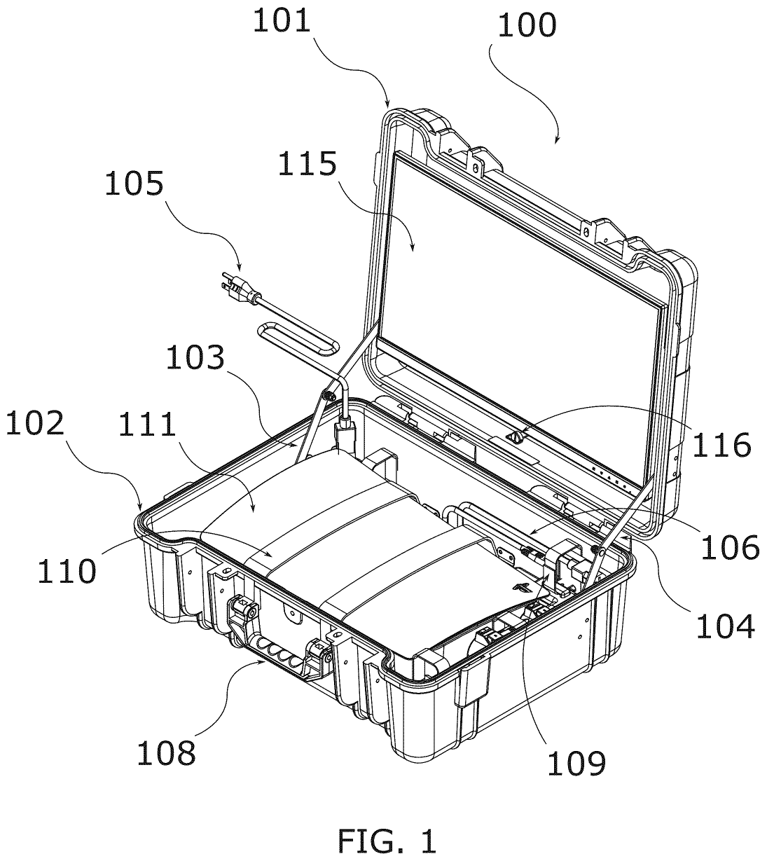

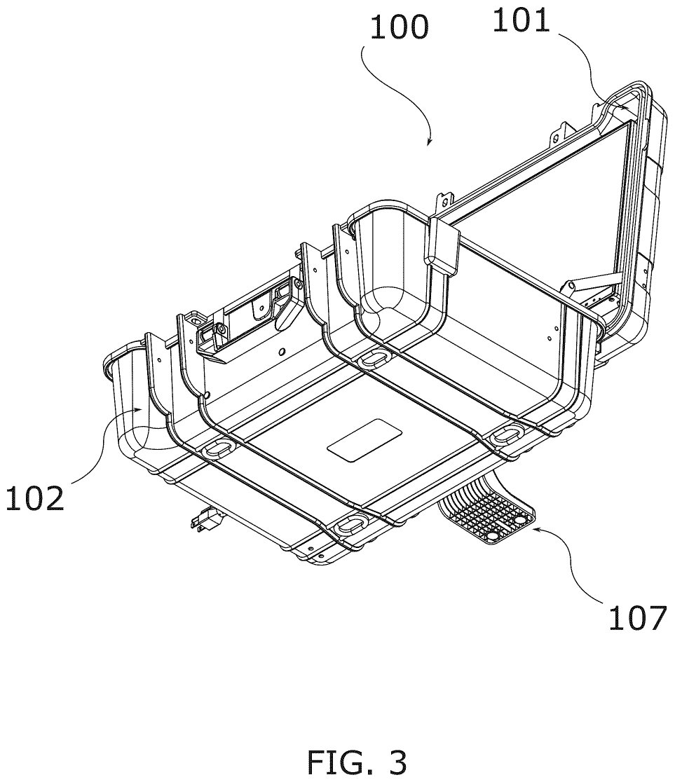

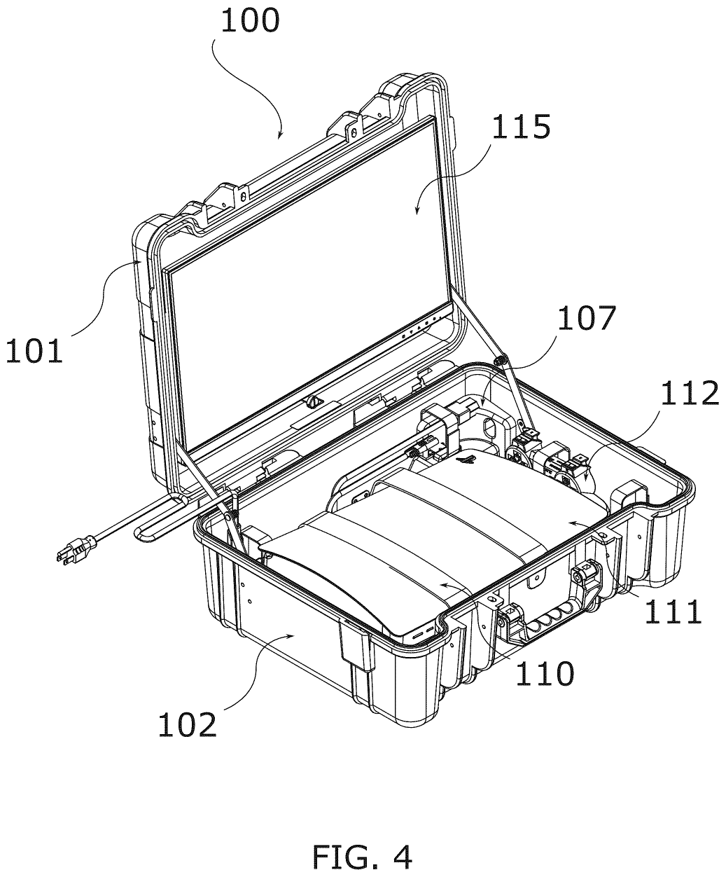

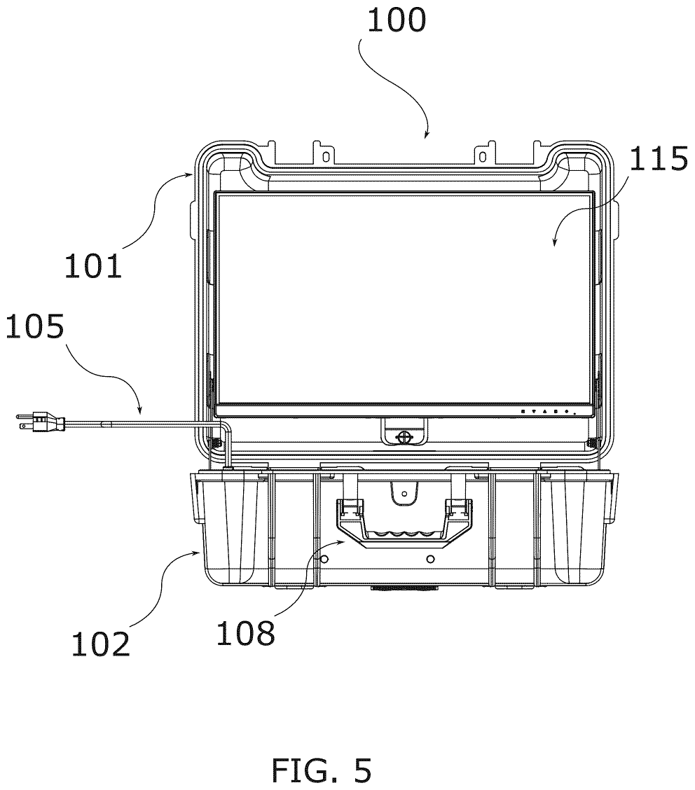

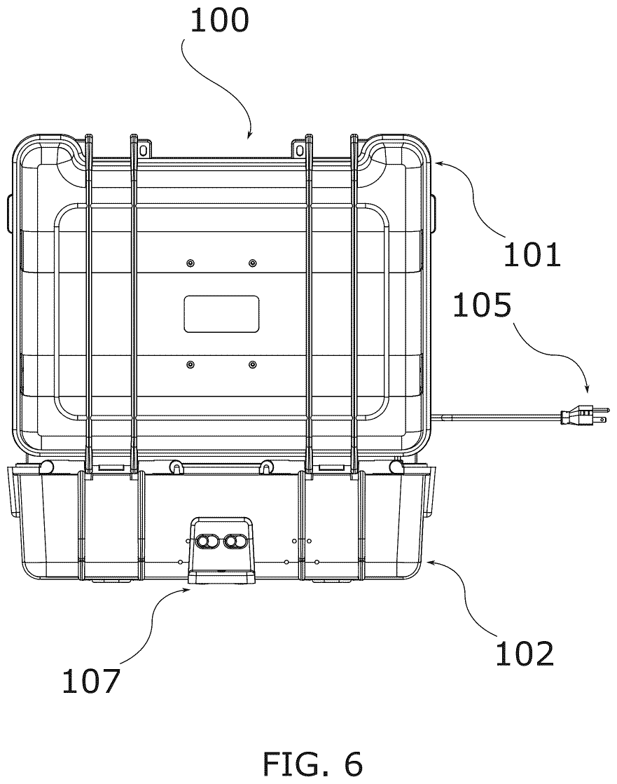

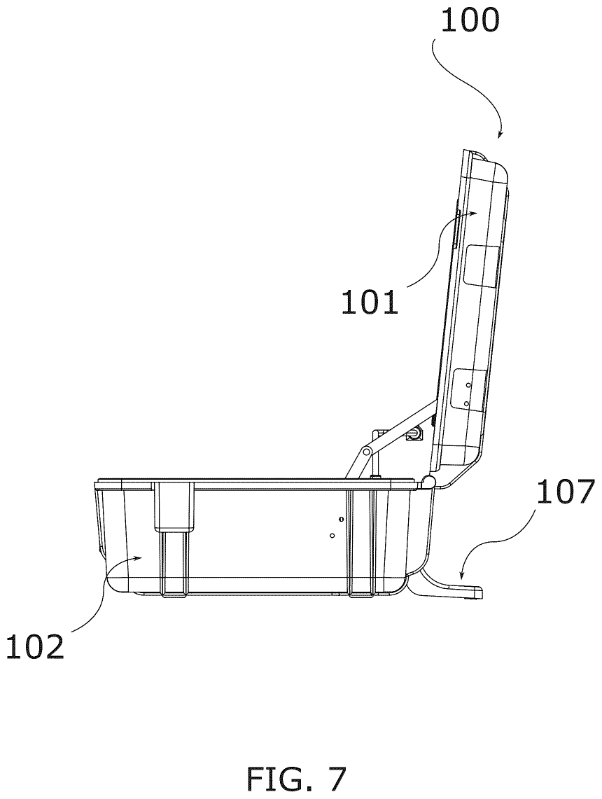

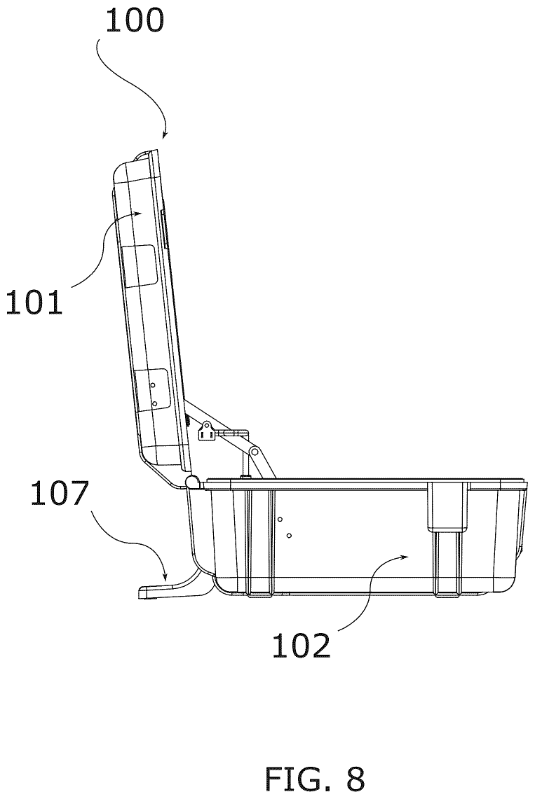

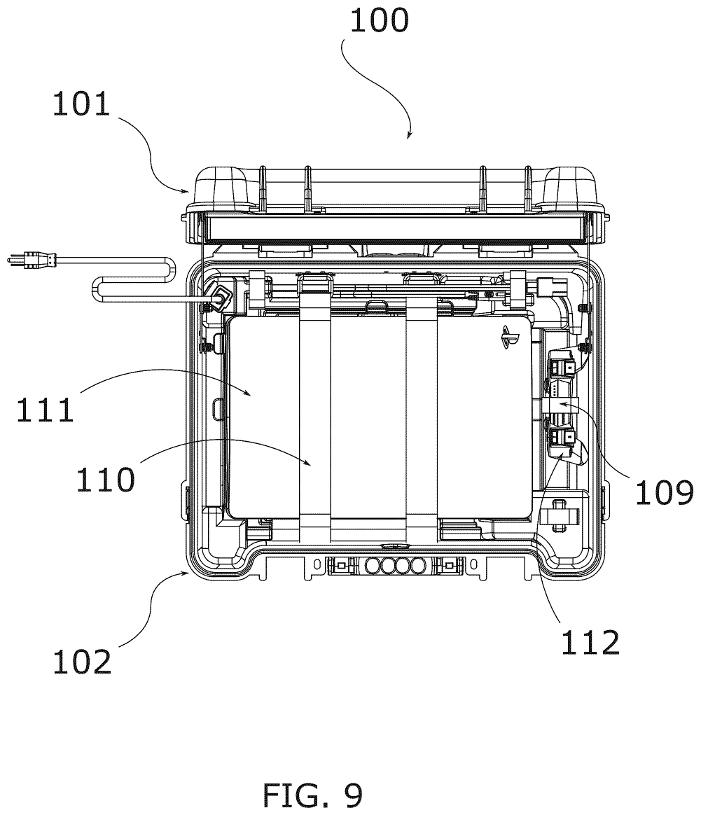

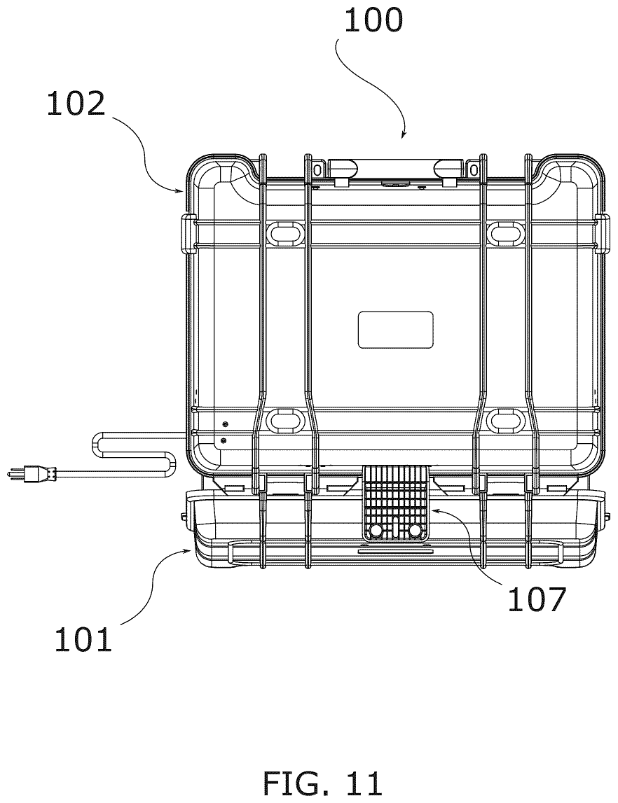

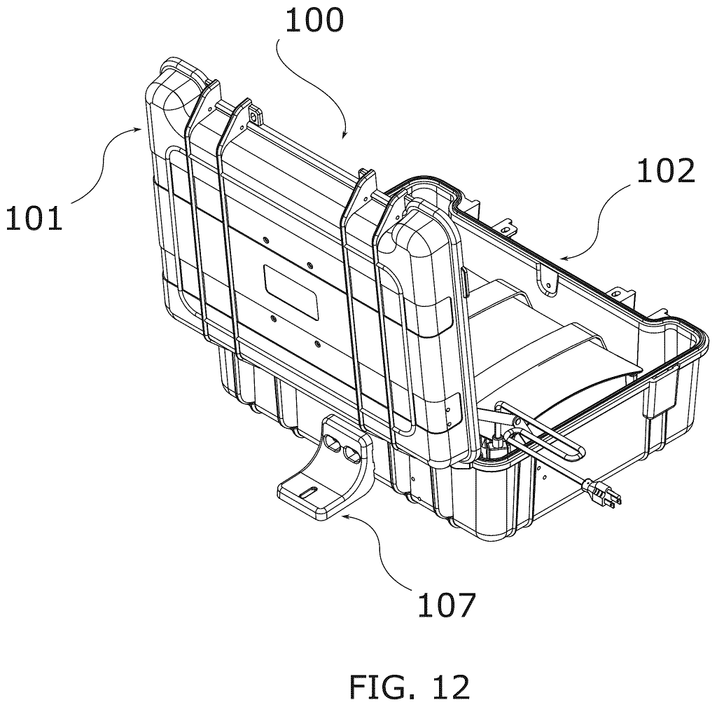

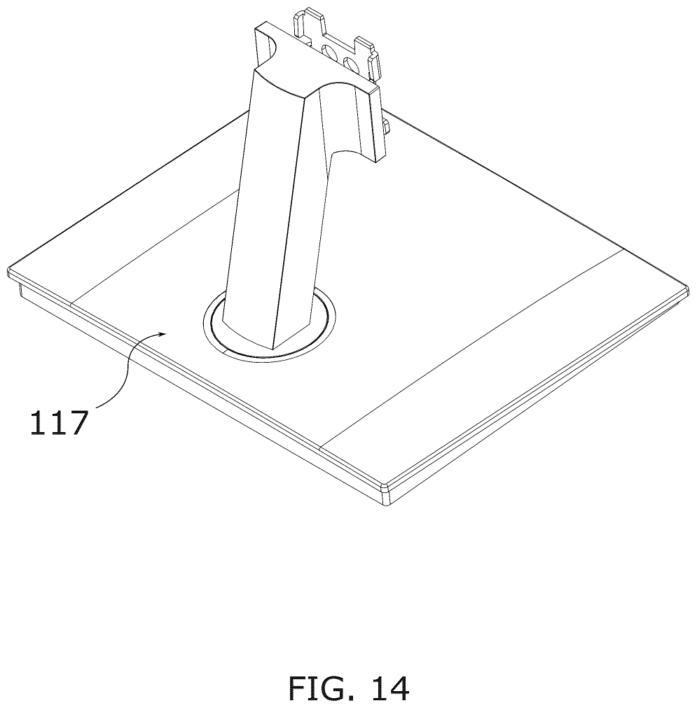

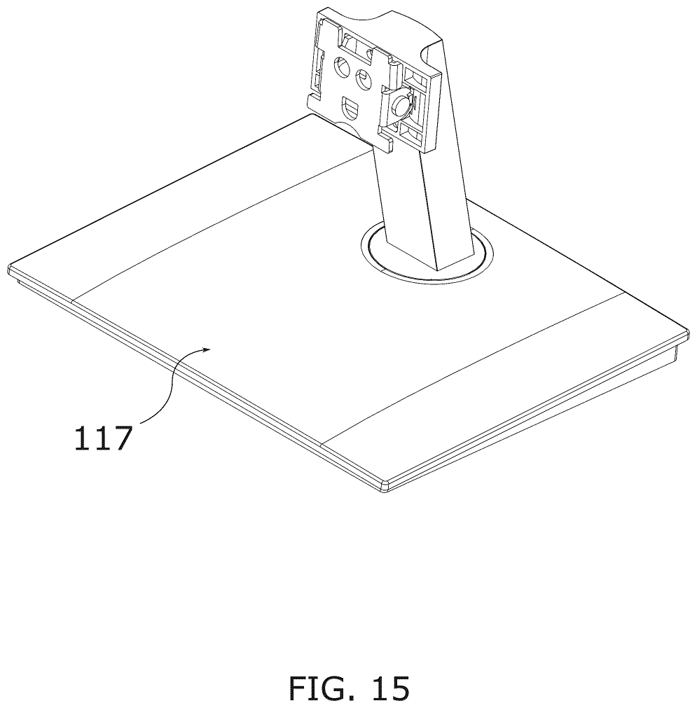

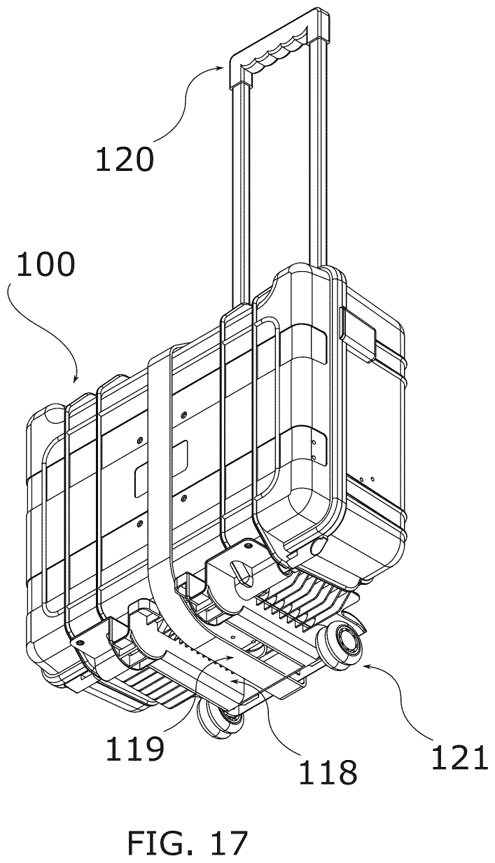

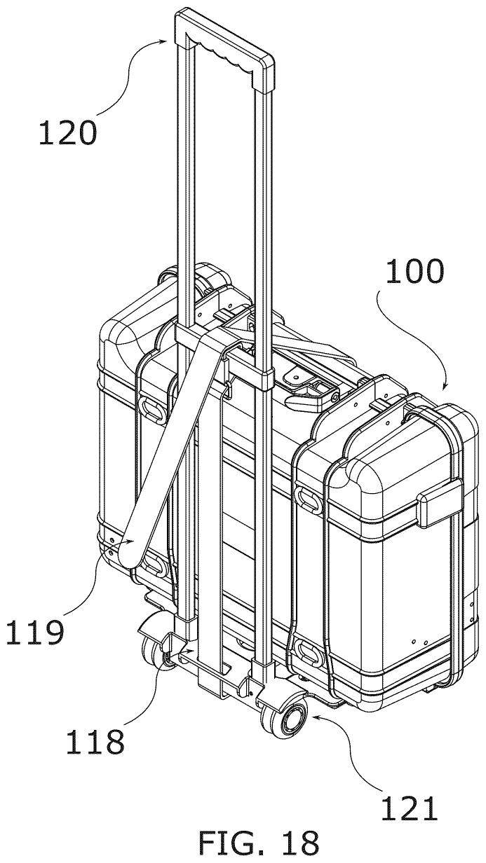

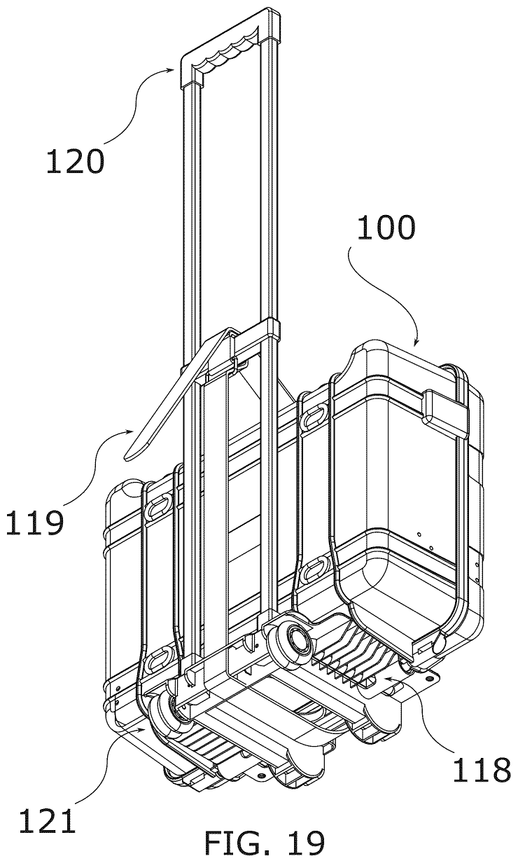

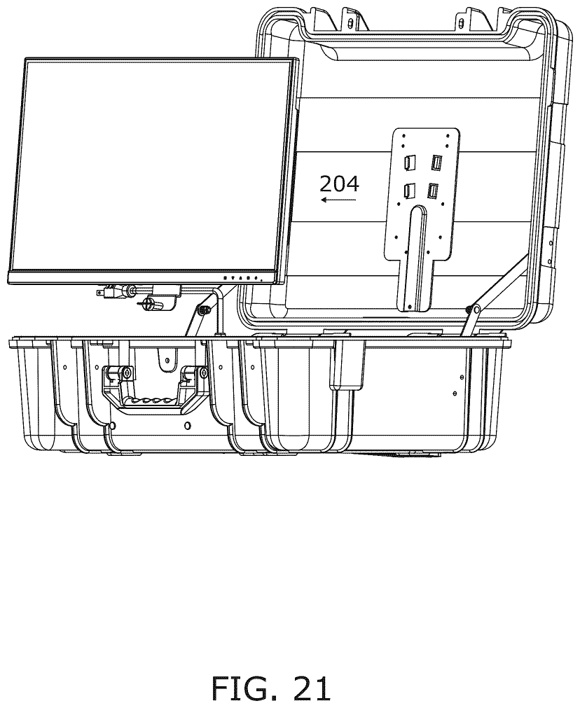

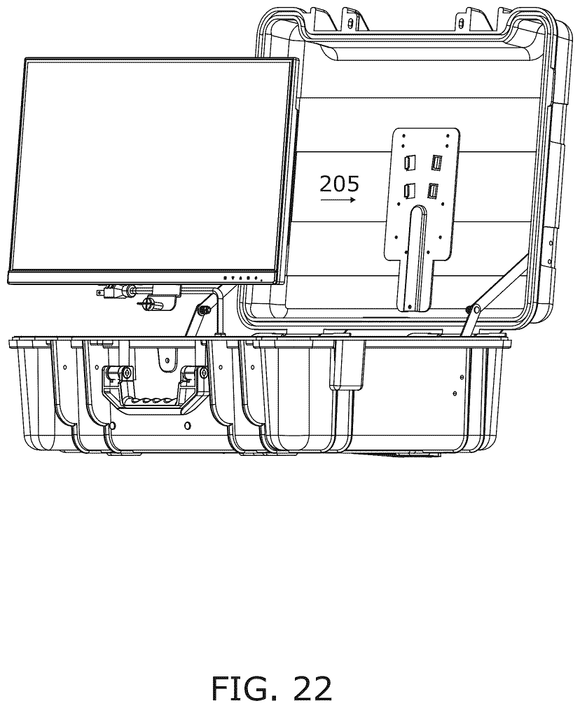

As shown in FIG. 1-22, the present invention is a case 100 comprising an upper case 101, a lower case 102, a left support hinge 103, a right support hinge 104, an AC connector 105, console wires 106, a detachable stability enhancement stand 107, a handle 108, a plurality of securing bands 109, a plurality of console straps 110, a console 111, a controller 112, a foam screen protector 113, a blister 114, a monitor 115, a monitor mount 116, a detachable monitor stand 117, a shock-absorbing trolley assembly 118, a trolley strap 119, a trolley handle 120, and a plurality of wheels 121.

Said upper case 101 and said lower case 102 fasten together to create a protective case 100. Said case 100 is designed to be rugged, protective, and water-resistant, offering shock-absorption and protection against water splashes, rain, and water jets. In the preferred embodiment of the present invention, said case 100 is 21.6 in or 550 mm wide, 16.5 in or 420 mm long, and 8.7 in or 220m tall. In the preferred embodiment of the present invention, said case 100 weighs 20.5lbs or 9.3 kg without said console 111. When closed, a user can move the present invention using the handle 108. Users have space to customize the upper case 101 or lower case 102 with logos or designs. In the preferred embodiment of the present invention, users can apply a customizable logo design up to 217×267 mm size on the upper case 101. In other embodiments, users can attach customizable LED lights for added lighting and/or visual effects during use. Other embodiments of the present invention may further comprise of at least one speaker for audio. In the preferred embodiment of the present invention, said case 100 is IP65 water and dust resistant, offering the benefits of durability, longevity, versatility, and peace of mind. Said case 100 is completely protected against dust ingress, ensuring that said console 111 remains clean and dust-free. Said case 100 is protected against low-pressure water jets from any direction and is resistant to splashes and light rain, protecting said console 111 from various environmental conditions. The IP65 rating signifies robust construction, providing additional protection against impacts, drops, and other physical damage. Enhanced protection from dust and water contributes to the extended lifespan of the present invention by preventing damage from these elements. An IP65-rated case 100 is suitable for various environments, whether at home, traveling, or attending events where exposure to dust and water can be a concern. Knowing the contents within the present invention are protected against common hazards allows for worry-free transportation and storage. In the preferred embodiment of the present invention, said case 100 is made of high-grade plastic raw material designed for impact resistance. Impact-resistant plastics are designed to withstand shocks and impacts, reducing the risk of damage from drops, bumps, and other physical stresses during transportation or storage. Gaming consoles 111 and screens 115 are delicate and can be easily damaged if dropped or hit. An impact-resistant storage case 100 provides a sturdy barrier that absorbs and disperses the force of impacts, protecting the internal components and screens from cracks or breaks. By providing robust protection, impact-resistant storage cases 100 help extend the lifespan of gaming consoles 111 and screens 115. This ensures that the devices remain functional and in good condition over time, reducing the need for repairs or replacements. Users may often transport consoles 111 and screens 115 to different locations, such as friends' houses, gaming events, or while traveling. An impact-resistant storage case 100 ensures that the equipment remains safe and secure during transit. Investing in a durable, impact-resistant storage case 100 can save money for a user in the long run by preventing costly repair or replacement of damaged equipment.

Said support hinges 103, 104 provide controlled resistance during the closing motion of the upper case 101 and lower case 102, ensuring that the upper case 101 closes gently and does not snap shut. The torque shafts of the support hinges 103, 104 are calibrated to engage at a specific angle, allowing the upper case 101 to close smoothly without the risk of pinching a user's fingers. Said support hinges 103, 104 further allow users to adjust the viewing angle of the upper case 101 with the built-in monitor 115 using a ratcheting mechanism found within the support hinges 103, 105 that provides multiple fixed positions. Users can easily adjust the viewing angle of the monitor 115 to a preferred angle, enhancing the ergonomic usability of the present invention. Adjustable view angles allow users to position the screen 115 at a comfortable viewing height and angle, reducing strain on the neck and eyes. This is particularly important during extended use. Different angles can affect the clarity, color accuracy, and contrast of the display. Adjusting the view angle ensures that the monitor 115 can be seen clearly from various positions, providing the best visual experience. Being able to adjust the angle helps minimize glare from lights or windows, which can improve visibility and reduce eye strain. Users can customize the screen position based on seating arrangement, whether users are sitting, standing, or sharing the screen with others. Adjustable angles make the display 115 more accessible for users of different heights and physical abilities, ensuring inclusivity and comfort for a wider range of users. For work or gaming setups, the ability to adjust the screen angle can enhance productivity by allowing for an optimal and comfortable setup tailored to individual needs.

Said AC connector 105 and said console wires 106 provide a single power cable solution. Said AC connector 105 is a single power cord from the present invention that connects to a wall AC outlet, providing power to the present invention. Said console wires 106 receive power and connect to various devices of the present invention, such as the console 111 and the monitor 115. Said plurality of securing bands 109 can be used to fasten down said console wires 106 for cable management and organization.

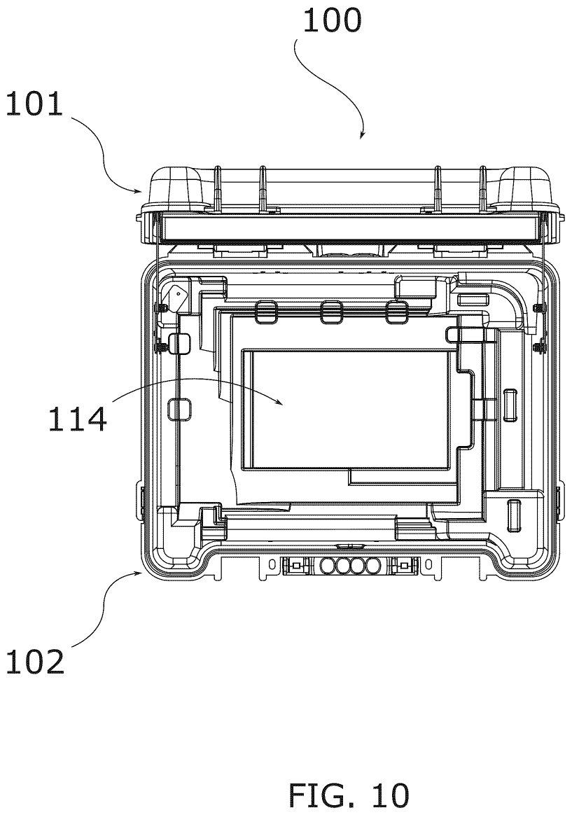

The present invention is compatible with a plurality of gaming consoles 111 utilizing a custom-shaped blister 114. As shown in FIG. 10, said blister 114 comprises a plurality of differently sized and shaped indentations. In the preferred embodiment of the present invention, said blister 114 allows the present invention to securely hold a Playstation 5 Disk, Playstation 5 Digital, Playstation 4 Pro, Playstation 4, Playstation 4 Slim, Xbox One X, or Xbox Series X console. The present invention may be compatible with other consoles available with different embodiments of said blister 114. Once said console 111 is placed secured in said blister 114, said console straps 110 can be fastened to prevent said console 111 from shifting. The lower case 102 has a space to fit a controller 112 which can be secured using a securing band 109.

Said stability enhancement stand 107 is a detachable component that provides added stability to the lower case 102 during use of the present invention. Said stability enhancement stand prevents the case 100 from falling backwards during use, particularly if the user prefers to use said monitor 115 with the built-in monitor mount 116 of the upper case 101. Said stability enhancement stand 107 can be stored inside the lower case 102 when not in use. Said stability enhancement stand 107 can be quickly attached to the lower case 102 in seconds, stopping the present invention from tipping over and preventing damage to the monitor 115 or the console 111.

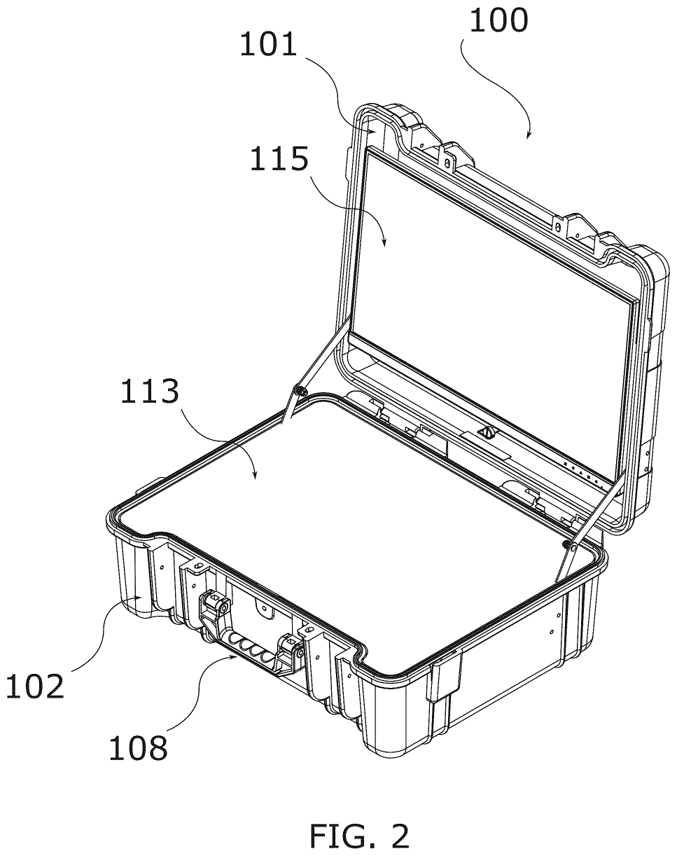

As shown in FIG. 2, in the preferred embodiment of the present invention, said foam screen protector 113 is made of 10 mm Expanded Polyethylene (EPE) foam designed to offer superior protection for electronic device screens. Said foam screen protector 113 provides exceptional shock absorption, reduces the risk of screen damage from impacts, absorbs and dissipates energy effectively, and minimizes force transmitted to the monitor screen 115. Said foam screen protector 113 is designed to be easily applied and removed without leaving residue, maintaining the present invention's aesthetic and functional qualities.

Said monitor 115 is a 21.5″ monitor screen that fits inside said upper case 101. In the preferred embodiment of the present invention, said monitor 115 is a 21.5″ Full HD IPS display with at least 1920×1080 resolution, at least 48 hz˜75 hz freesync rate, and 5 ms response time or faster with overdrive. Said monitor 115 connects to said upper case 101 by said monitor mount 116. Said monitor 115 is removable for replacement, upgrade, or use as a desktop monitor.

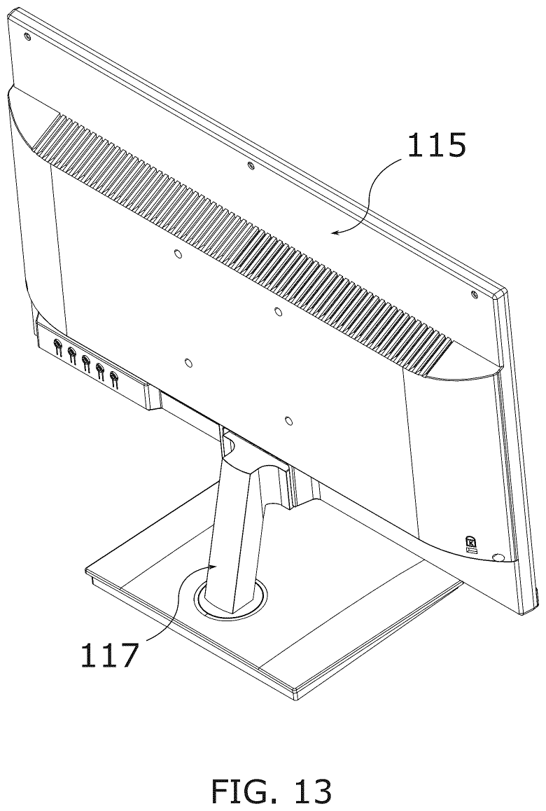

Using said detachable monitor stand 117, users can mount said monitor 115 as a detached screen from the upper case 101. As shown in FIG. 13-15, said detachable monitor stand 117 is an option for users that prefer to place said monitor 115 on a tabletop or other surface.

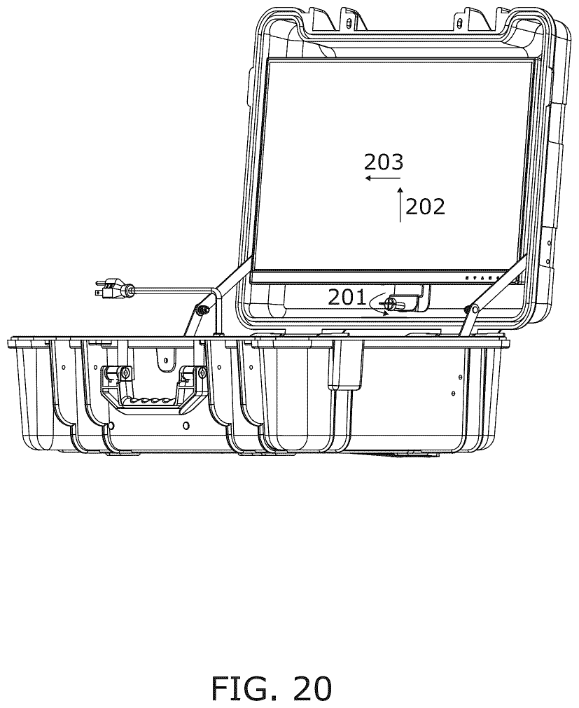

Said monitor mount 116 is a quick detach mechanism that allows users to mount or dismount said monitor 115. As shown in FIG. 20-22, rotating 201 said monitor mount, lifting 202 said monitor, and pulling 203 said monitor allows the user to dismount 204 said monitor. A monitor may be mounted 205 onto said monitor mount.

Benefits of a detachable monitor 115 include flexibility, cost-effective upgrades, easy maintenance, versatility, portability, customization, extended lifespan, and improved user experience. A detachable monitor 115 allows users to easily upgrade to a newer or higher-quality display without replacing the present invention as a whole. Flexibility ensures that the present invention can keep up with technological advancements. Instead of replacing the present invention as a whole, users can replace the monitor 115 as needed, especially whenever a newer model with improved features becomes available. If the monitor 115 is damaged or malfunctions, said monitor 115 can be replaced independently of the present invention as a whole, simplifying repairs and reducing downtime. A detachable monitor can be used as a standalone desktop monitor, providing more functionality. Use as a standalone desktop monitor is especially useful for both gamers and professionals who need a larger or secondary display for multitasking. When traveling, users can choose to leave the monitor 115 behind and connect to another display at their destination, reducing the amount of equipment carried in the present invention. Users can select monitors and screens that best meet their specific needs, such as those with higher resolutions, better color accuracy, or specific aspect ratios. By allowing monitor replacements and upgrades, the overall lifespan of the present invention is extended, as users can continually update only the display component without discarding the present invention as a whole. Having the option to upgrade can significantly enhance the user experience, providing clearer, more vibrant visuals and better performance tailored to the user's needs.

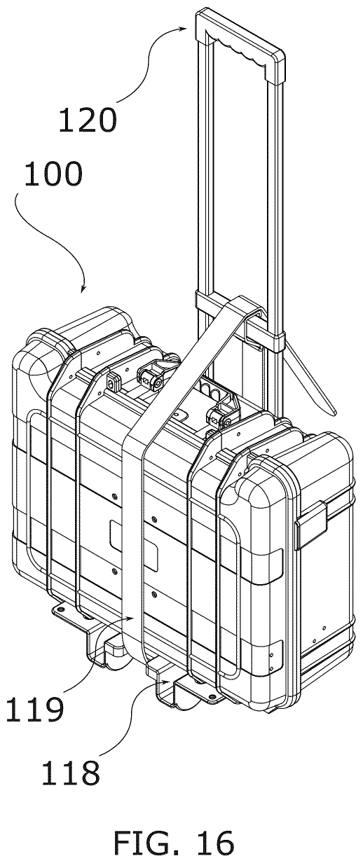

As shown in FIG. 16-19, said trolley assembly 118 further comprises a shock-absorbing mechanism. Said mechanism connects the chassis of the trolley assembly 118 to said plurality of wheels 121 utilizing springs or dampers to absorb initial impacts. Said trolley assembly 118 is detachable from the case 100. When the case 100 is in the closed position, a user can securely attach the case 100 to the trolley assembly 118 with said trolley strap 119. Once secured, a user can roll the trolley assembly 118 by pulling the trolley handle 120. In the preferred embodiment of the present invention, said trolley handle 120 can extend and retract like common luggage handles.

In addition to console gaming, the present invention may be used for other applications such as, but not limited to, drones, cameras, karaoke, medical equipment, testing instruments, and as a mobile office. Because the present invention has a customizable interior, a 1.5×1.5 cm grid style extractable sponge allows optimal fixation for these different applications. Said sponge can be pre-cut to adapt for said different applications and fit various shapes of equipment.

Although the invention has been explained in relation to its preferred embodiment, it is to be understood that many other possible modifications and variations can be made without departing from the spirit and scope of the invention.

What is claimed is:

1. A case comprising:
an upper case;
a lower case;
a left support hinge;
a right support hinge;
an AC connector;
a plurality of console wires;
a handle;
a blister;
a shock-absorbing trolley assembly;
a trolley strap;
a trolley handle; and
a plurality of wheels.

2. The case of claim 1, further comprising:
a detachable stability enhancement stand.

3. The case of claim 1, further comprising:
a plurality of securing bands.

4. The case of claim 1, further comprising:
a plurality of console straps;
a console; and
at least one controller.

5. The case of claim 1, further comprising:
a foam screen protector.

6. The case of claim 1, further comprising:
a monitor; and
a monitor mount.

7. The case of claim 6, further comprising:
a detachable monitor stand.

8. The case of claim 1, further comprising:
customized lighting.

9. The case of claim 1, further comprising:
at least one speaker for audio.

10. A case comprising:
an upper case;
a lower case;
a left support hinge;
a right support hinge;
an AC connector;
a plurality of console wires;
a handle;
a plurality of securing bands;
a plurality of console straps;
a console;
at least one controller;
a blister;
a shock-absorbing trolley assembly;
a trolley strap;
a trolley handle; and
a plurality of wheels.

11. The case of claim 10, further comprising:
a detachable stability enhancement stand.

12. The case of claim 10, further comprising:
a foam screen protector.

13. The case of claim 10, further comprising:
a monitor; and
a monitor mount.

14. The case of claim 13, further comprising:
a detachable monitor stand.

15. The case of claim 10, further comprising:
customized lighting.

16. The case of claim 10, further comprising:
at least one speaker for audio.

17. A case comprising:
an upper case;
a lower case;
a left support hinge;
a right support hinge;
an AC connector;
a plurality of console wires;
a detachable stability enhancement stand;
a handle;
a plurality of securing bands;
a plurality of console straps;
a console;
at least one controller;
a foam screen protector;
a blister;
a monitor;
a monitor mount;
a shock-absorbing trolley assembly;
a trolley strap;
a trolley handle; and
a plurality of wheels.

18. The case of claim 17, further comprising:
a detachable monitor stand.

19. The case of claim 17, further comprising:
customized lighting.

20. The case of claim 17, further comprising:
at least one speaker for audio.
